(19) United States
(12) Patent Application Publication
(10) Pub. No.: US 2011/0215513 A1
(43) Pub. Date: Sep. 8, 2011

(54) SHEET PROCESSING APPARATUS AND FINISHER CONNECTING METHOD

(75) Inventor: Naofumi SOGA, Shizuoka (JP)

(73) Assignees: Kabushiki Kaisha Toshiba, Tokyo (JP); Toshiba Tec Kabushiki Kaisha, Tokyo (JP)

(21) Appl. No.: 13/038,353

(22) Filed: Mar. 1, 2011

Related U.S. Application Data
(60) Provisional application No. 61/311,256, filed on Mar. 5, 2010.
(60) Provisional application No. 61/318,257, filed on Mar. 26, 2010.
(60) Provisional application No. 61/318,258, filed on Mar. 26, 2010.

(51) Int. Cl. B41L 43/02; F16M 13/00; B41L 43/12; B23P 11/00

(52) U.S. Cl. 270/37; 248/646; 270/58.08; 29/428

(57) ABSTRACT

According to one embodiment, a sheet processing apparatus includes: a finisher connectable to an image forming apparatus; a first castor attached to a bottom surface of the finisher and configured to support the finisher; a finishing unit provided in the finisher and configured to subject sheets sent from the image forming apparatus to finishing and discharge the sheets, the finishing unit being capable of being drawn out from the finisher; and a second castor attached to a front end in a drawing-out direction of the finishing unit and configured to support the finishing unit when the finishing unit is drawn out from the finisher.

### CROSS-REFERENCE TO RELATED APPLICATION

This application is based upon and claims the priority of U.S. Provisional Application No. 61/311,256, filed on Mar. 5, 2010, and U.S. Provisional Application No. 61/318,257, filed on Mar. 26, 2010, and U.S. Provisional Application No. 61/318,258, filed on Mar. 26, 2010, the entire contents of which are incorporated herein by reference.

### FIELD

Embodiments described herein relate generally to a sheet processing apparatus and a finisher connecting method for connecting a finisher to an image forming apparatus.

### BACKGROUND

In recent years, in an image forming apparatus (e.g., a MFP), in order to subject sheets after image formation to finishing, a sheet processing apparatus is provided adjacent to a post stage of the MFP. The sheet processing apparatus is called finisher. The finisher staples sheets sent from the MFP or punches the sheets and discharges the sheets to a storage tray from a discharge port. Some sheet processing apparatus includes a folding unit configured to fold sheets in half and discharge the sheets.

If the finisher is attached to the post stage of the MFP, the height of a paper discharge port of the MFP and the height of a paper feeding port of the finisher are designed to be the same. However, if a floor surface on which the MFP and the finisher are set is not flat, takes long time to adjust the heights of the paper discharge port and the paper feeding port. If sheets are conveyed from the MFP to the finisher, in general, the height of the finisher is adjusted to the height of the paper discharge port provided on a main body side of the MFP and the MFP and the finisher are connected. However, since the finisher includes plural castors, difficult to find a horizontal position of the finisher and the finisher tends to tilt between a conveying upstream side and a conveying downstream side. Therefore, adjust the height of the finisher is difficult.

Even if the height is adjusted, if the MFP is set in a place like a carpet, in some case, the MFP having large weight sinks as time elapses and the height shifts. If a difference in level between the MFP and the finisher is too large, in some case, force in an up down direction is applied to a connecting section of the MFP and the finisher more than necessary and the MFP and the finisher cannot be smoothly connected.

Further, if the height of the paper discharge port and the height of the paper feeding port are different, in some case, sheets are incompletely passed from the MFP to the finisher and a jam occurs. If a jam occurs in the finisher, the folding unit and the like are drawn out from a finisher main body and a sheet jammed in the finisher is removed. However, for example, if the folding unit is drawn out from the finisher in order to eliminate the jam, in some case, the center of gravity of the finisher shifts, a load balance changes, and a load is applied to precision components in the MFP.

### BRIEF DESCRIPTION OF THE DRAWINGS

FIG. 1 is a diagram of a sheet processing apparatus according to a first embodiment, wherein an image forming apparatus and a finisher are separately shown;

FIG. 2 is a sectional view of the configuration of a supporting section for a castor in the first embodiment;

FIG. 3 is a perspective view of a connecting mechanism in the first embodiment;

FIG. 4 is a perspective view of a state in which a folding unit is drawn out from the finisher in the first embodiment;

FIG. 5 is a perspective view of a state in which the folding unit is drawn out and separated from the finisher in the first embodiment;

FIG. 6 is a diagram of a modification of the sheet processing apparatus according to the first embodiment, wherein the image forming apparatus and the finisher are separately shown;

FIG. 7 is a schematic explanatory diagram of a state in which a punch unit is fixed to the finisher in the first embodiment;

FIG. 8 is a schematic explanatory diagram of a state in which the punch unit is fixed to the image forming apparatus in the first embodiment;

FIG. 9 is a diagram of a sheet processing apparatus according to a second embodiment, wherein an image forming apparatus and a finisher are separately shown;

FIG. 10 is a diagram of an example in which the finisher and the image forming apparatus are connected in the second embodiment;

FIG. 11 is a diagram of another example in which the finisher and the image forming apparatus are connected in the second embodiment;

FIG. 12 is a sectional view of a spring member used in the second embodiment;

FIG. 13 is a sectional view of a specific example of a connecting mechanism in the second embodiment; and

FIG. 14 is a sectional view of a modification of the spring member in the second embodiment.

### DETAILED DESCRIPTION

In general, according to one embodiment, a sheet processing apparatus includes:

a finisher connectable to an image forming apparatus;

a first castor attached to a bottom surface of the finisher and configured to support the finisher;

a finishing unit provided in the finisher and configured to subject sheets sent from the image forming apparatus to finishing and discharge the sheets, the finishing unit capable of being drawn out from the finisher; and

a second castor attached to a front end in a drawing-out direction of the finishing unit and configured to support the finishing unit when the finishing unit is drawn out from the finisher.

An image forming apparatus and a finisher connecting method according to the first embodiment is explained in detail below with reference to the accompanying drawings. In the figures, the same components are denoted by the same reference numerals and signs.

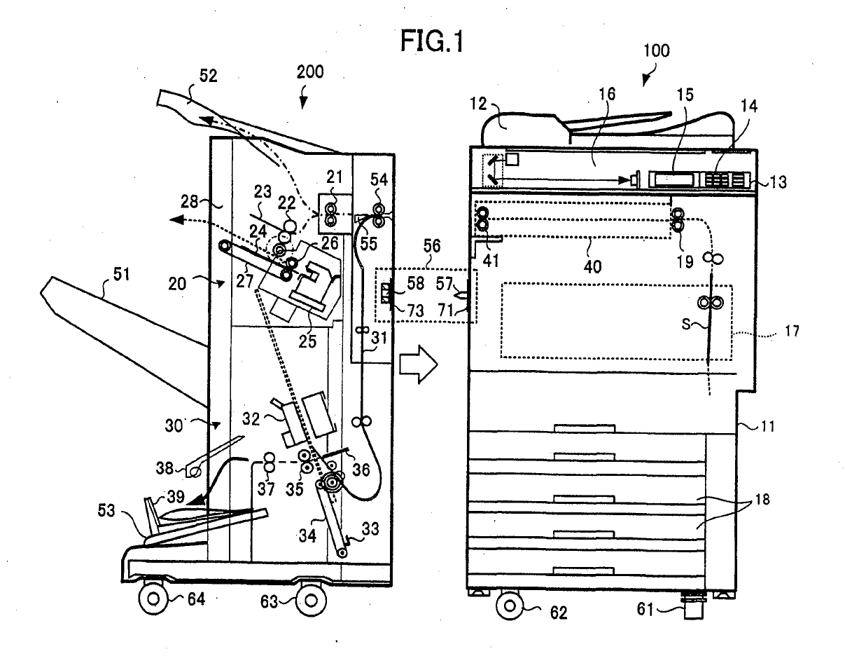

In FIG. 1, an image forming apparatus 100 is, for example, a MFP (Multi-Function Peripheral) as a complex machine, a printer, or a copying machine. The MFP is explained below as an example of the image forming apparatus 100. A sheet finishing apparatus 200 is arranged adjacent to the MFP 100. A sheet on which an image is formed by the MFP 100 is conveyed to the sheet finishing apparatus 200.

The sheet processing apparatus 200 performs finishing, for example, sorting or stapling of sheets supplied from the image forming apparatus 100. If necessary, the sheet processing apparatus 200 folds the sheets in half and discharges the sheets. The sheet finishing apparatus 200 is hereinafter referred to as finisher 200. In FIG. 1, a state in which the MFP 100 and the finisher 200 are separated is shown.

A document table is provided in an upper part of a main body 11 of the MFP 100. An auto document feeder (ADF) 12 is openably and closably provided on the document table. An operation panel 13 is provided in an upper part of the main body 11. The operation panel 13 includes an operation section 14 including various keys and a display section 15 of a touch panel type.

A scanner section 16 is provided below the ADF 12 in the main body 11. The scanner section 16 reads an original document fed by the ADF 12 or an original document placed on the document table and generates image data. The MFP 100 includes a printer section 17 in the center in the main body 11. The MFP 100 includes plural cassettes 18, which store sheets of various sizes, in a lower part of the main body 11.

The printer section 17 configures an image forming section. The printer section 17 includes a photoconductive drum, a laser, etc. The printer section 17 processes image data read by the scanner section 16 or image data created by a PC (Personal Computer) or the like and forms an image on a sheet.

The printer section 17 scans and exposes the surface of the photoconductive drum with a laser beam from the laser and forms an electrostatic latent image on the photoconductive drum. A charging device, a developing device, a transfer device, and the like are arranged around the photoconductive drum. The electrostatic latent image on the photoconductive drum is developed by the developing device and a toner image is formed on the photoconductive drum. The toner image is transferred onto a sheet by the transfer device. The toner image transferred onto the sheet is fixed by a fixing device. The configuration of the printer section 17 is not limited to the example explained above. There are various systems as the configuration of the printer section 17.

A sheet S having an image formed thereon by the printer section 17 is discharged via a paper discharge roller 19 and a sheet conveying path 40. A paper discharge roller 41 is provided at an outlet of the sheet conveying path 40.

If the finisher 200 is connected to a post stage of the MFP 100, the sheet S discharged by the paper discharge roller 41 is conveyed to the finisher 200. The finisher 200 includes, as a finishing unit, for example, a staple unit 20 and a folding unit 30 configured to fold sheets in half. The finisher 200 includes a storage tray 51, a fixed tray 52, and a storage tray 53. Sheets stapled or sorted by the staple unit 20 are discharged to the storage tray 51. The sheets folded in half by the folding unit 30 are discharged to the storage tray 53.

The sheet S conveyed by the paper discharge roller 41 is received by an inlet roller 21 of the staple unit 20 via a conveying roller 54. A paper feeding roller 22 is provided on a downstream side of the inlet roller 21. The paper feeding roller 22 sends the sheet S received by the inlet roller 21 to a standby tray 23. Each of the inlet roller 21 and the paper feeding roller 22 includes an upper roller and a lower roller.

A processing tray 24 on which the sheet S dropped from the standby tray 23 is stacked is arranged below the standby tray 23. The standby tray 23 is stacked with the sheet S and is structured to be openable. If a preset number of the sheets S are accumulated on the standby tray 23, the standby tray 23 opens and the sheets S drops to the processing tray 24 with own weight of the sheets S or according to an action of a drop supporting member. When the sheets S are stapled by a stapler 25, the processing tray 24 is stacked with the sheets S in alignment.

The sheets S stacked on the processing tray 24 are aligned in a longitudinal direction, which is a conveying direction, by a longitudinal alignment roller 26. A lateral alignment plate for aligning the sheets S in a lateral direction orthogonal to the conveying direction is provided. The lateral alignment plate performs lateral alignment and sorting of the sheets S.

A conveyor belt 27 configured to convey the stapled sheets S to the storage tray 51 are provided. The sheets S conveyed by the conveyor belt 27 are discharged to the storage tray 51 via a discharge port 28. The storage tray 51 rises and falls to receive the sheets S. In some case, the sheets S are discharged to the storage tray 51 without being stapled. If the sheets S are not stapled, the sheets S are discharged without being dropped to the processing tray 24. If finishing is not performed, sheets conveyed from the MFP 100 are discharged to the fixed tray 52.

The folding unit 30 bundles plural sheets supplied from the MFP 100 and folds the sheets in half. The sheet S conveyed from the MFP 100 is conveyed in the direction of a stapler 32 via a paper path 31 and once received by a stack tray 33. The sheets S sequentially conveyed from the MFP 100 are stacked on the stack tray 33 to form a sheet bundle.

The sheet bundle on the stack tray 33 is conveyed in the direction of the stapler 32 by a guide belt 34. When the center of the sheet bundle reaches the stapler 32, the guide belt 34 once stops and the center of the sheet bundle is stapled.

The sheet bundle stapled by the stapler 32 is lowered by the guide belt 34. The center of the sheet bundle stops in a position of a nip point of a folding roller pair 35. A blade 36 is arranged in a position opposed to the folding roller pair 35.

The blade 36 projects the center of the sheet bundle to the nip point of the folding roller pair 35 and pushes the sheet bundle into a space between the folding roller pair 35. The folding roller pair 35 rotates while folding and nipping the sheet bundle and folds the sheet bundle in half. The sheet bundle folded in half is conveyed by a discharge roller pair 37 and discharged to the storage tray 53. A driving motor is provided in order to drive to rotate the folding roller 35 and the discharge roller pair 37.

In order to switch and convey the sheets S, which are supplied, from the MFP 100, to the staple unit 20 or the folding unit 30, a gate 55 is provided at the outlet of the conveying roller 54.

The storage tray 51 can rise and fall and receives the sheets S discharged from the staple unit 20. The storage tray 53 receives the sheet bundle folded in half by the folding unit 30. A pressing mechanism 38 configured to press the sheet bundle folded in half and a stopper 39 configured to receive the discharge sheet bundle are provided near the storage tray 53.

The storage tray 53 can be drawn out to make easy to take out the sheet bundle folded in half. Legs 61 and castors 62 are attached to the bottom surface of the MFP 100. Castors 63 and 64 are attached to the bottom surface of the finisher 200. The castors 63 and 64 are supporting legs for supporting the finisher 200. The castors 63 and 64 include flexible springs.

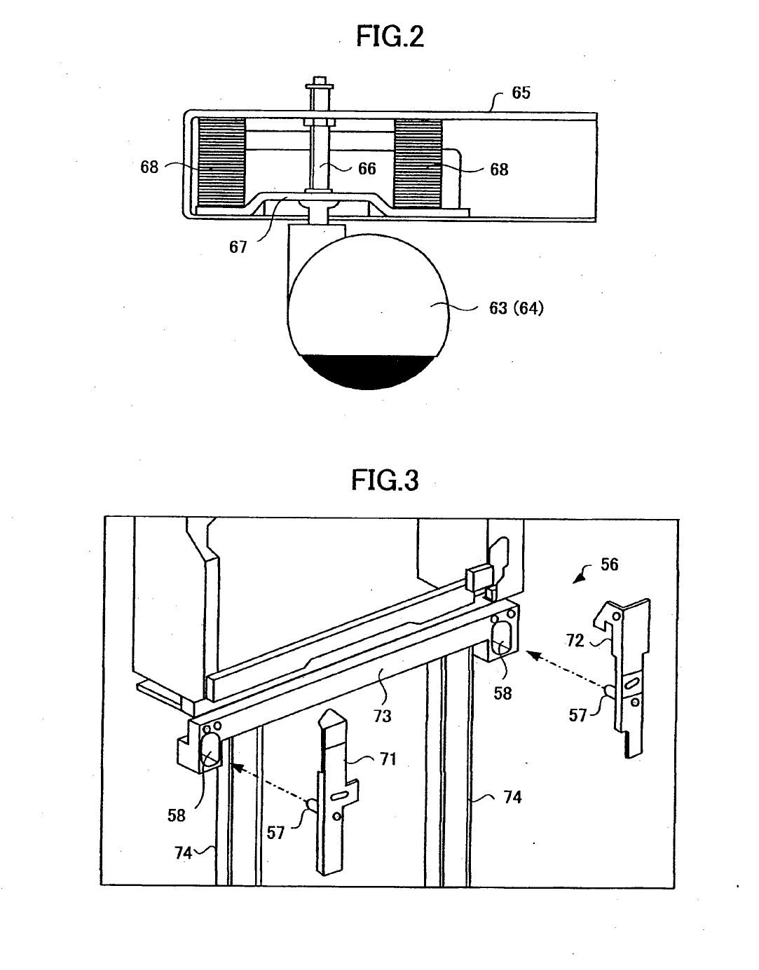

FIG. 2 is a sectional view of the configuration of a supporting section configured to support the castor 63 (or 64). The supporting section for the castor 63 includes a supporting member 65 attached to the bottom surface of the finisher 200, a shaft 66 configured to support the castor 63, a movable member 67 configured to support the castor 63 to be movable in an axis direction thereof, and flexible coil-like springs 68 provided between the supporting member 65 and the movable member 67. The castor 63 (or 64) can rotate around the shaft 66.

A connecting mechanism 56 configured to connect the MFP 100 and the finisher 200 is provided in the centers of surfaces where the MFP 100 and the finisher 200 are opposed to each other. The connecting mechanism 56 includes, for example, studs 57 provided in the MFP 100 and sockets 58 provided in the finisher 200. The studs 57 are inserted into the sockets 58 to connect the MFP 100 and the finisher 200.

FIG. 3 is an enlarged perspective view of the connecting mechanism 56. A state in which an outer cover of the finisher 200 is removed is shown. The connecting mechanism 56 includes first couplers 71 and 72 including the studs 57 and a second coupler 73 including the sockets 58 into which the studs 57 are inserted. The first couplers 71 and 72 are attached to the MFP 100. The second coupler 73 is attached to a frame 74 that forms a framework of the finisher 200. In FIG. 3, the MFP 100 is not shown.

If the finisher 200 is connected to the MFP 100, the studs 57 of the first couplers 71 and 72 are respectively inserted into the sockets 58 of the second coupler 73, whereby the height position of the finisher 200 is adjusted with respect to the MFP 100.

If both of the MFP 100 and the finisher 200 are stand-alone apparatuses, even if there is a difference in level, unevenness, or the like on a floor surface on which the MFP 100 and the finisher 200 are set, a difference in setting height can be absorbed to some extent by the springs 68 attached to the castors 63 of the finisher 200. However, if the height adjustment for the MFP 100 and the finisher 200 is not successfully performed, in some case, conveyance of a sheet cannot be successfully performed and a jam is caused.

If a jam occurs in, for example, the folding unit 30 of the finisher 200, the folding unit 30 is drawn out to the front side and a sheet jammed in the folding unit 30 is taken out. However, if the folding unit 30 is drawn out from the finisher 200 in order to eliminate the jam, the center of gravity of the finisher 200 shifts. If the center of gravity shifts, in some case, a load is applied to, in particular, the front side of the connecting mechanism 56, a load balance changes, and the finisher 200 cannot be sufficiently supported by the connecting mechanism 56.

When the folding unit 30 is drawn out to the front side, since the castors 63 support the weight of the folding unit 30, a load is applied to the castors 63. Therefore, necessary to use thick springs as the springs 68 of the castors 63. Further, if the load balance changes, in some case, a load is applied to precision components in the MFP 100 via the connecting mechanism 56.

Therefore, in the first embodiment, the change in the load balance is reduced when the folding unit 30 is drawn out.

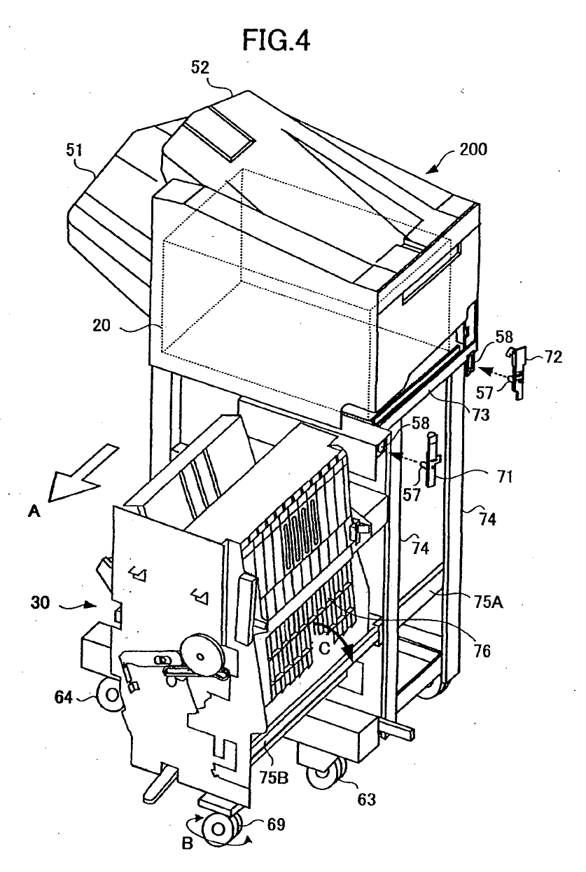

FIG. 4 is a perspective view of the finisher 200 in which the folding unit 30 serving as a finishing unit can be drawn out to the front side. The outer peripheries of the staple unit 20 and the folding unit 30 are covered with covers. However, a part of the covers can be removed when a jam is eliminated or maintenance is performed. In FIG. 4, a state in which the covers are removed is shown to specifically show the configuration of the folding unit 30.

As shown in FIG. 4, the finisher 200 is supported by the frame 74 that forms the framework. The folding unit 30 can be drawn out to the front side (in an arrow A direction) from the finisher 200. Castors 69 are provided at the bottom at the front end (the front side) in a drawing-out direction of the folding unit 30. The castors 69 have the same configuration as, for example, that shown in FIG. 2.

As a guide in drawing out the folding unit 30, flexible slide rails 75A and 75B are provided in the frame 74. The folding unit 30 can move to the front side along the slide rails 75A and 75B. When the folding unit 30 is drawn out, the front side of the folding unit 30 is supported by the castors 69. Therefore, possible to prevent the finisher 200 from falling down to the front side.

If the castors 69 are not provided, when the folding unit 30 is drawn out, the center of gravity shifts to the front side of the finisher 200. The front side is heavier and the rear side is lighter. If the center of gravity shifts to the front side, a load is intensely applied to the first coupler 71, the finisher 200 cannot be sufficiently supported by the connecting mechanism 56, and a deficiency such as breakage of the first coupler 71 occurs. In some case, the finisher 200 falls down.

On the other hand, if the castors 69 are provided, since the folding unit 30 is supported by the castors 69, the center of gravity does not shift to the front side of the finisher 200. Therefore, possible to prevent a load from intensely applied to the connecting mechanism 56 and prevent the finisher 200 from falling down.

The castors 69 can rotate in an arrow B direction around the shaft 66 (FIG. 2). Therefore, when the folding unit 30 is drawn out, since the castors 69 rotate in the drawing-out direction, the folding unit 30 is easily drawn out.

In the folding unit 30, a guide plate 76 forming a wall on a side surface can be opened and closed. For example, the guide plate 76 can be opened in an arrow C direction with a downward end as a fulcrum. Therefore, if a sheet is jammed in the folding unit 30, possible to open the guide plate 76 and eliminate the jam.

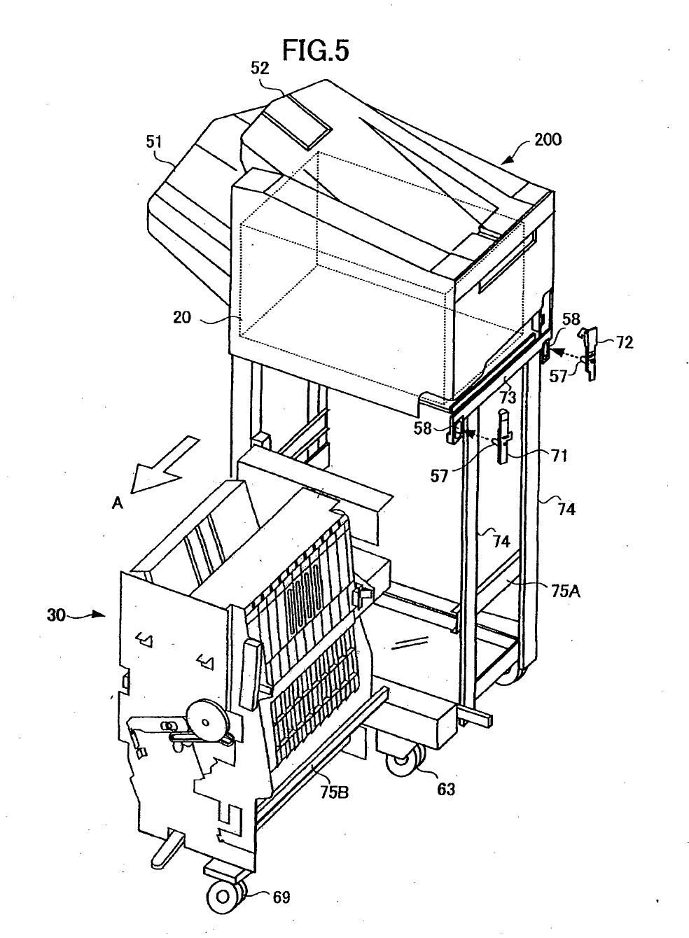

The folding unit 30 may be completely drawn out and separated from the finisher 200 as shown in FIG. 5. Since the folding unit 30 is completely drawn out, the finisher 200 can be released from the influence due to the shift of the center of gravity.

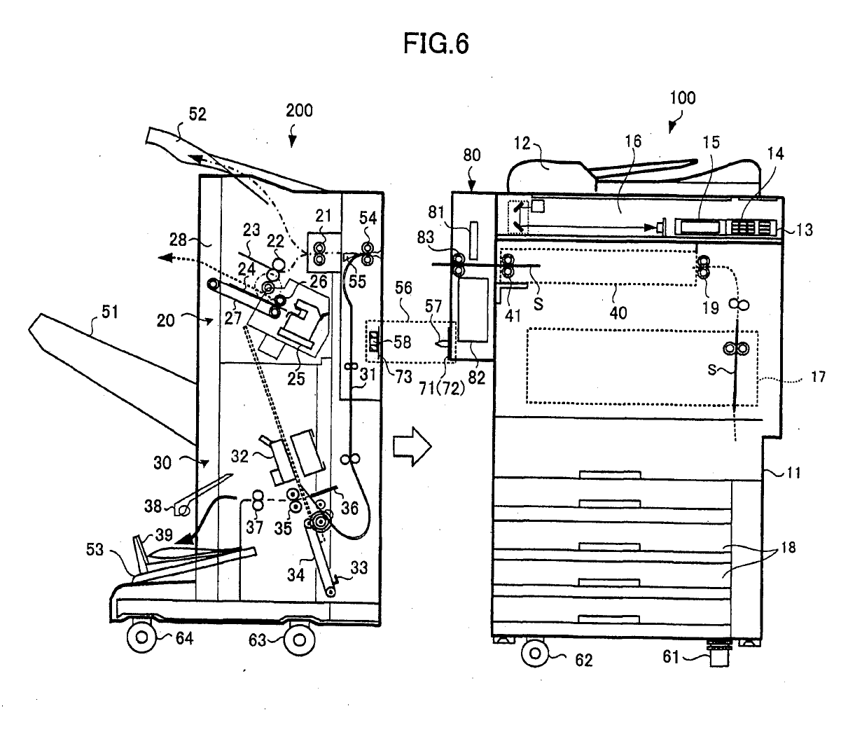

FIG. 6 is a diagram of a modification of the sheet processing apparatus further including another processing unit, for example, a punch unit 80.

The punch unit 80 serving as a processing unit is arranged between the MFP 100 and the finisher 200 and fixed to the MFP 100. The punch unit 80 includes a punch box 81 and a dust box 82. The punch box 81 includes a punching blade for applying punching to sheets. The punching blade descends in order to punch the sheets. Punch dust caused by the punching drops into the dust box 82.

A conveying roller 83 is provided at an outlet of the punch unit 80. The conveying roller 83 conveys a sheet, which is discharged from the paper discharge roller 41 of the MFP 100, to the punch unit 80 and conveys the sheet S passed through the punch unit 80 to the conveying roller 54 of the finisher 200. The punching by the punch unit 80 is performed if a user operates the operation panel 13 and sets a punch mode.

The first couplers 71 and 72 are attached to a surface opposed to the finisher 200 at the lower end of the punch unit 80. The second coupler 73 is attached to the finisher 200 to be opposed to the first couplers 71 and 72. The first couplers 71 and 72 and the second coupler 73 have structures same as those shown in FIG. 3.

If the finisher 200 is connected to the MFP 100 to which the punch unit 80 is fixed, the studs 57 of the first couplers 71 and 72 are respectively inserted into the sockets 58 of the second coupler 73, whereby the height position of the finisher 200 is adjusted with respect to the MFP 100. If there is a difference in level, unevenness, or the like on the floor surface on which the MFP 100 and the finisher 200 are set, a difference in setting height can be absorbed to by the springs 68 attached to the castors 63 of the finisher 200.

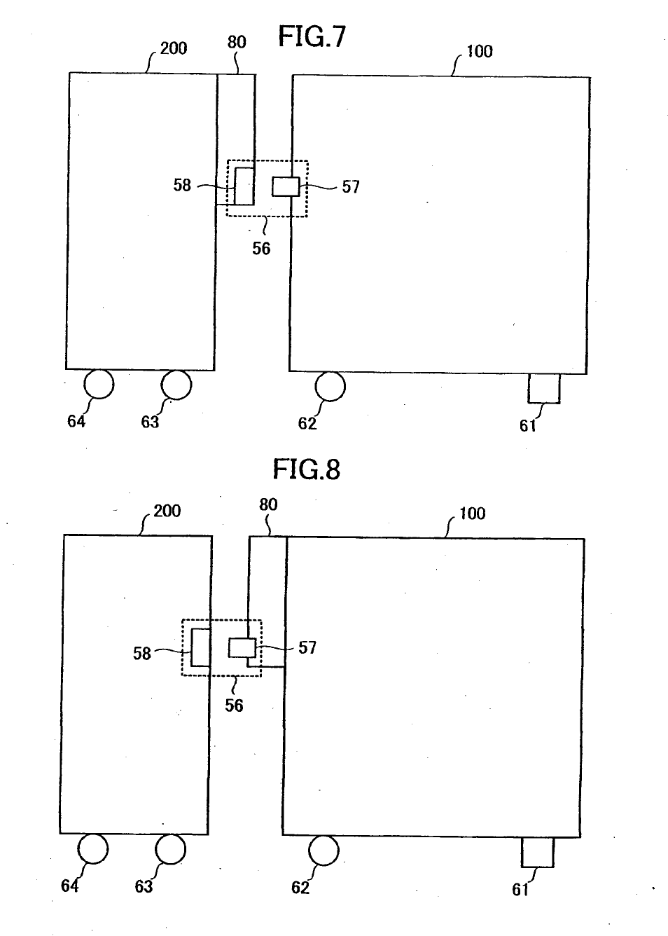

FIG. 7 is an explanatory diagram for explaining a load applied to the connecting section 56 if the punch unit 80 is fixed to the finisher 200. FIG. 8 is an explanatory diagram for explaining a load applied to the connecting unit 56 if the punch unit 80 is fixed to the MFP 100 (equivalent to FIG. 6).

Assumed that the MFP 100 and the finisher 200 are set in the same height position, and assumed that the springs 68 of the castors 63 are attached as designed. However, if another processing unit (e.g., the punch unit 80) is combined with the finisher 200 and used, in some case, the load changes and the studs 57 of the connecting mechanism 56 cannot be correctly inserted into the sockets 58.

For example, as shown in FIG. 7, if the punch unit 80 is attached to the finisher 200 and the connecting mechanism 56 (the first couplers 71 and 72 and the second coupler 73) is attached to the punch unit 80, the weight of the punch unit 80 is applied to the finisher 200. If the weight of the punch unit 80 is applied, the springs 68 of the castors 63 contract and the height position of the finisher 200 with respect to the MFP 100 changes. The studs 57 cannot be correctly inserted into the sockets 58. An unexpected load is applied to the connecting mechanism 56.

On the other hand, as shown in FIG. 8, if the punch unit 80 is fixed to the MFP 100, the weight of the finisher 200 does not change. Therefore, if the MFP 100 and the finisher 200 are present in the same height position, the studs 57 can be smoothly inserted into the sockets 58. The application of the unexpected load to the connecting mechanism 56 can be reduced and a connection load can be appropriately set.

In the example shown in FIG. 6, the punch unit 80 is fixed to the MFP 100. Another processing unit such as a sheet inserter may be fixed to the MFP 100 instead of the punch unit 80.

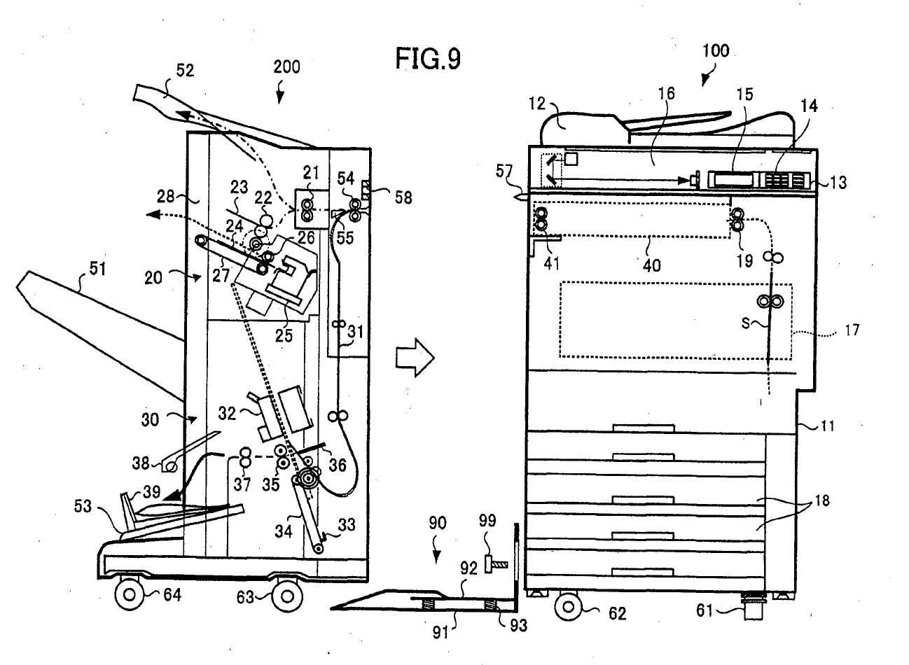

A sheet processing apparatus according to a second embodiment is explained with reference to FIG. 9.

In the first embodiment, even if there is a slight difference between the setting heights of the MFP 100 and the finisher 200, the difference is absorbed by the expansion and contraction of the springs 68 of the castors 63 and 64. However, in the second embodiment, a spring member 90 is attached to the bottom of the finisher 200. In the castors 63 and 64, the springs 68 are removed.

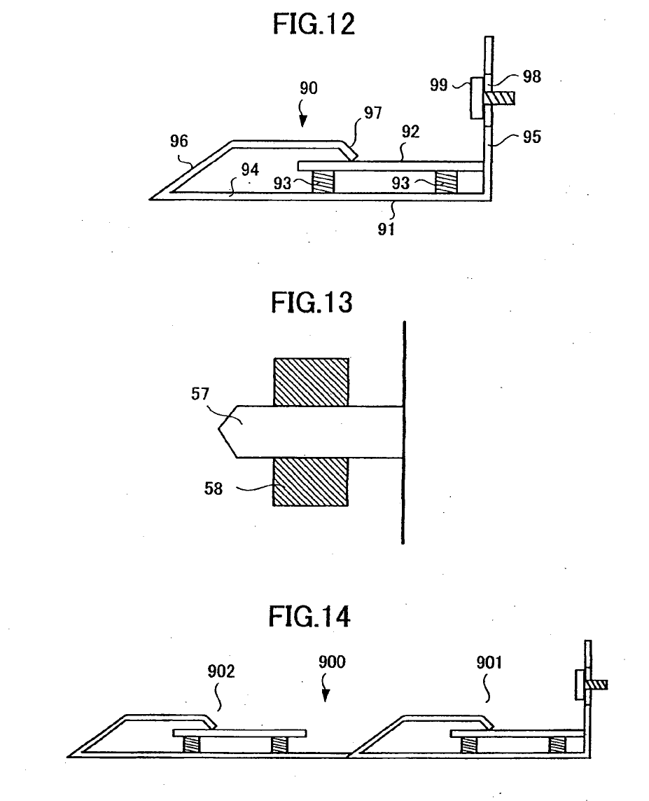

As shown in FIG. 9, the spring member 90 is attached to a lower part of a surface of the MFP 100 opposed to the finisher 200. As shown in FIG. 12 in enlargement, the spring member 90 is a two-layer structure of a sheet metal 91 and a sheet metal 92. Springs 93 are arranged between the sheet metal 91 and the sheet metal 92.

In FIG. 12, the sheet metal 91 includes a flat bottom surface 94, a vertical surface 95 that extends vertically from one end of the bottom surface 94 and is fixed to a side surface of the MFP 100, a slope 96 formed by folding and tilting the other end of the bottom surface 94 in the direction of the MFP 100, and a pressing section 97 that extends from the slope 96 and presses the second sheet metal 92.

A long hole 98 is formed in the vertical direction in the vertical surface 95. A screw 99 is inserted into the long hole 98 to attach the sheet metal 91 to the MFP 100. Therefore, the height position of the spring member 90 can be changed within a range of the length of the long hole 98 with reference to a floor setting surface. Since the castors 63 are provided on the front side and the rear side of the finisher 200, a pair of the spring members 90 are respectively arranged on the front side and the rear side.

The connecting mechanism 56 is provided near a sheet conveying path in upper parts of the MFP 100 and the finisher 200. The MFP 100 and the finisher 200 are connected by inserting the studs 57 into the sockets 58. In other words, the castors 63 of the finisher 200 are mounted on the spring members 90, the springs 93 expands and contracts with reference to the sheet conveying path, and a setting surface of the castors 63 fluctuates.

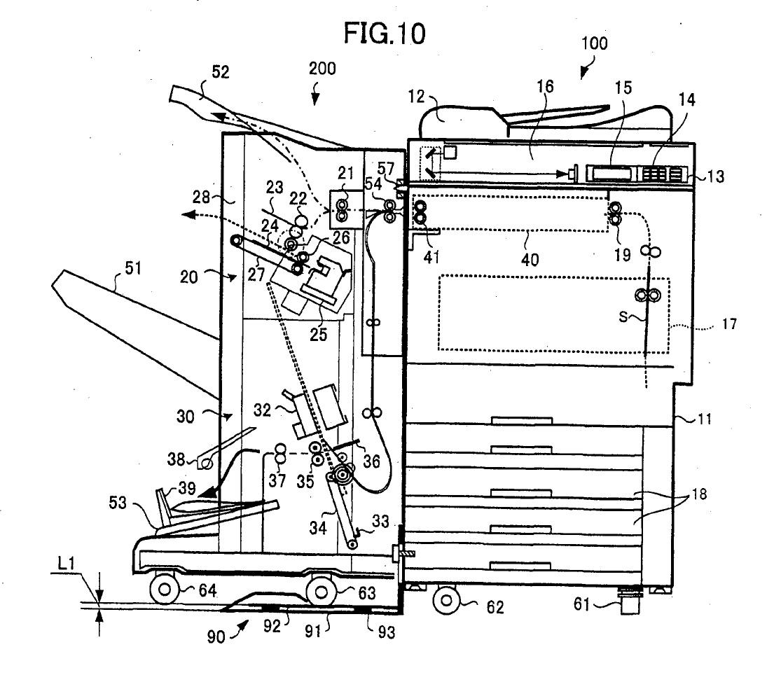

FIG. 10 is a diagram of a state in which the finisher 200 is mounted on the spring members 90 and the MFP 100 and the finisher 200 are coupled. If the finisher 200 is pushed to the MFP 100 side, the castors 63 roll on the slopes 96 of the spring members 90 and get on the second sheet metal 92.

As shown in FIG. 10, the studs 57 are inserted into the sockets 58 to connect the MFP 100 and the finisher 200. If the floor surface of the finisher 200 is higher, the springs 93 is contract. If the springs 93 contract, the finisher 200 sinks and a distance between the bottom surface of the castors 63 and the floor surface decreases to L1.

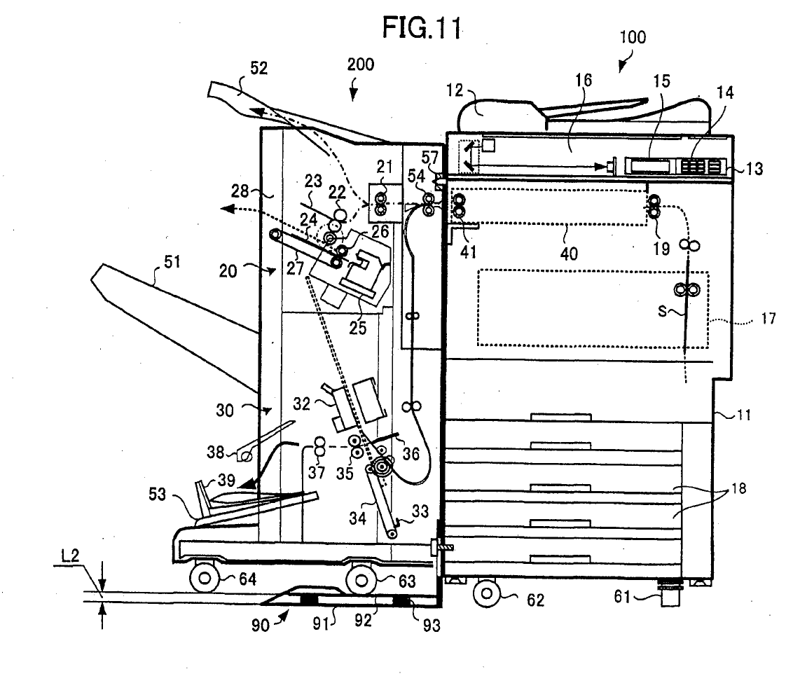

As shown in FIG. 11, the studs 57 are inserted into the sockets 58 to connect the MFP 100 and the finisher 200. If the floor surface of the finisher 200 is lower, the springs 93 expand. If the springs 93 expand, a sinking amount of the finisher 200 decreases and the distance between the bottom surface of the castors 63 and the floor surface increases to L2 (L1<L2).

Therefore, even if there is unevenness or a difference in level on the floor surface on which the MFP 100 and the finisher 200, the unevenness or the difference in level can be absorbed by the spring members 90. For example, if a range of expansion and contraction of the springs 93 is set to about ±10 mm from the height of a design value, even if the heights of setting surfaces of the MFP 100 and the finisher 200 are different, a dent amount of the floor surface changes because of a difference in weight, or actual machine height changes between models, a shift within the range of ±10 mm can be adjusted by the expansion and contraction of the springs 93.

The finisher 200 can be connected to the MFP 100 at the same height simply by connecting the finisher 200 to insert the studs 57 into the sockets 58. Therefore, the connection is easy.

FIG. 13 is a sectional view of contact of the stud 57 and the socket 58 of the connecting mechanism 56. The thickness of the socket 58 is set to preset thickness with respect to the length direction of the stud 57, whereby the stud 57 and the inner surface of the socket 58 come into line contact with each other.

In other words, if the thickness of the socket 58 is small, the stud 57 and the socket 58 are in a state close to point contact. Therefore, if the height position of the finisher 200 is changed by the spring members 90, the finisher 200 tilts with a point contact section as a fulcrum. Therefore, be possible to suppress the finisher 200 from tilting by bringing the stud 57 and the socket 58 into line contact with each other.

The spring members 90 is not always arranged to correspond to the castors 63 of the finisher 200 on the MFP 100 side and may be arranged to correspond to the castors 64.

FIG. 14 is a sectional view of spring members 900 set to correspond to the castors 63 and 64. In each of the spring members 900, a pair of the spring members 90 shown in FIG. 12 are coupled on the left and the right. The spring member 900 includes spring members 901 and 902. The castors 63 are mounted on the spring members 901 and the castors 64 are mounted on the spring members 902.

Since the castors 63 and 64 are symmetrically provided on the front side and the rear side of the finisher 200, the spring members 900 are also arranged on the front side and the rear side. Therefore, be possible to prevent the finisher 200 from tilting by supporting the castors 63 and 64 respectively with the spring members 901 and 902.

As explained above, in the sheet processing apparatus or the finisher connecting method according to the first or second embodiment, even if a difference in level occurs in the connecting section of the MFP 100 and the finisher 200 possible to reduce the influence of the difference in level and smoothly convey the sheet S from the MFP 100 to the finisher 200.

The present invention is not limited to the embodiments. Various modifications of the embodiments are possible. For example, the examples of the staple unit 20 and the folding unit 30 of the finisher 200 are merely explained above. The staple unit 20 and the folding unit 30 are not limited to the structures shown in the figures. Other structures of the staple unit 20 and the folding unit 30 are also conceivable.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A sheet processing apparatus comprising:
a finisher connectable to an image forming apparatus;
a first castor attached to a bottom surface of the finisher and configured to support the finisher;
a finishing unit provided in the finisher and configured to subject sheets sent from the image forming apparatus to finishing and discharge the sheets, the finishing unit capable of being drawn out from the finisher; and
a second castor attached to a front end in a drawing-out direction of the finishing unit and configured to support the finishing unit when the finishing unit is drawn out from the finisher.

2. The apparatus of claim 1, wherein the finishing unit can be drawn out and separated from the finisher.

3. The apparatus of claim 1, further comprising a connecting mechanism including first and second couplers respectively attached to the image forming apparatus and the finisher, wherein
a stud is provided in one of the first and second couplers and a socket into which the stud is inserted is provided in the other to connect the image forming apparatus and the finisher.

4. The apparatus of claim 1, wherein
the first castor include a flexible spring that supports the finisher, and
the second castor includes a flexible spring that supports the finishing unit.

5. The apparatus of claim 1, wherein
the finisher includes a staple unit serving configured to staple the sheets and a folding unit provided below the staple unit and configured to fold the sheets in half as the finishing unit,
the folding unit can be drawn out from the finisher, and
the second castor is attached at a front end in a drawing-out direction of the folding unit.

6. A sheet processing apparatus comprising:
a finisher connectable to an image forming apparatus and configured to subject sheets sent from the image forming apparatus to first finishing and discharge the sheets;
a castor attached to a bottom surface of the finisher and including a spring that supports the finisher;
a processing unit fixed to the image forming apparatus and configured to subject the sheets sent from the image forming apparatus to second finishing and discharge the sheets; and
a connecting mechanism including first and second couplers respectively attached to the processing unit and the finisher, a stud being provided in one of the first and second couplers and a socket into which the stud is inserted being provided in the other to connect the processing unit and the finisher.

7. The apparatus of claim 6, wherein
the processing unit is a punch unit configured to punch the sheets sent from the image forming apparatus,
the finisher includes a staple unit configured to staple the sheets or a folding unit configured to fold the sheets in half,
the first coupler is attached to a position opposed to the finisher below a sheet conveying path of the processing unit, and
the second coupler is attached to the finisher to be opposed to the first coupler.

8. A sheet processing apparatus comprising:
a finisher connectable to an image forming apparatus and configured to subject sheets sent from the image forming apparatus to finishing and discharge the sheets;
a castor attached to a bottom surface of the finisher and configured to support the finisher;
a connecting mechanism including first and second couplers respectively attached to the image forming apparatus and the finisher, a stud being provided in one of the first and second couplers and a socket into which the stud is inserted being provided in the other to connect the image forming apparatus and the finisher; and
a spring member attached to a lower part of a surface of the image forming apparatus opposed to the finisher and configured to support the castor of the finisher and expand and contract with weight of the finisher.

9. The apparatus of claim 8, wherein the spring member includes:
a first sheet metal extending in parallel to a setting surface of the image forming apparatus or the finisher;
a second sheet metal arranged spaced apart from and in parallel to the first sheet metal; and
a flexible spring provided between the first sheet metal and the second sheet metal.

10. The apparatus of claim 9, wherein, in the spring member, an end of the first sheet metal on the finisher side is bent in a taper shape to form a slope and the castor is placed on the slope and guided to the second sheet metal.

11. The apparatus of claim 8, wherein an attaching position of the spring member can be changed within a preset height range with respect to the image forming apparatus.

12. The apparatus of claim 8, wherein, if there are a plurality of the castors of the finisher, the spring member is provided to correspond to at least the castor present on the image forming apparatus side.

13. The apparatus of claim 8, wherein the first and second couplers of the connecting mechanism are attached near a sheet conveying path for conveying the sheets from the image forming apparatus to the finisher and within a preset distance from the sheet conveying path.

14. The apparatus of claim 8, wherein thickness of the socket is set such that the stud and the socket of the connecting mechanism come into line contact with each other.

15. A finisher connecting method comprising:
attaching a first castor configured to support the finisher to a bottom surface of a finisher connectable to an image forming apparatus;
providing a finishing unit in the finisher configured to subject sheets sent from the image forming apparatus to finishing and discharge the sheets, the finishing unit being capable of being drawn out from the finisher; and
attaching a second castor to a front end in a drawing-out direction of the finishing unit to support the finishing unit with the second castor when the finishing unit is drawn out from the finisher.

16. The method of claim 15, further comprising:
providing a connecting mechanism including first and second couplers respectively attached to the image forming apparatus and the finisher; and
providing a stud in one of the first and second couplers and providing a socket into which the stud is inserted in the other to connect the image forming apparatus and the finisher.

17. The method of claim 15, wherein
the finisher includes:
a staple unit serving as the finishing unit configured to staple the sheets; and
a folding unit provided below the staple unit and configured to fold the sheets in half,
the folding unit can be drawn out from the finisher, and
the folding unit is supported by the second castor when the folding unit is drawn out.

18. A finisher connecting method comprising:
making a finisher connectable to an image forming apparatus, the finisher being configured to subject sheets sent from the image forming apparatus to first finishing and discharge the sheets;
attaching a castor including a spring that supports the finisher to a bottom surface of the finisher;
fixing a processing unit to the image forming apparatus, subjecting the sheets sent from the image forming apparatus to second finishing, and conveying the sheets to finisher; and
attaching first and second couplers respectively to the processing unit and the finisher, providing a stud in one of the first and second couplers, and providing a socket into which the stud is inserted in the other to connect the processing unit and the finisher.

19. A finisher connecting method comprising:
making a finisher connectable to an image forming apparatus, the finisher being configured to subject sheets sent from the image forming apparatus to finishing and discharge the sheets;
attaching a castor to a bottom surface of the finisher and supporting the finisher;
attaching first and second couplers respectively to the image forming apparatus and the finisher, providing a stud in one of the first and second couplers, and providing a socket into which the stud is inserted in the other to connect the image forming apparatus and the finisher; and
attaching a spring member configured to expand and contract with weight of the finisher to a lower part of a surface of the image forming apparatus opposed to the finisher and supporting the castor of the finisher with the spring member.

20. The method of claim 19, wherein, if there are a plurality of the castors of the finisher, the spring member is provided to correspond to at least the castor present on the image forming apparatus side.
